(19) United States
(12) Patent Application Publication
(10) Pub. No.: US 2010/0094685 A1
(43) Pub. Date: Apr. 15, 2010

(54) SYSTEM AND METHOD FOR DETERMINING A VALUE FOR AN ENTITY

(76) Inventor: AMY LAUREN YOUNG, East Hampton, NY (US)

Correspondence Address: COLLARD & ROE, P.C., 1077 NORTHERN BOULEVARD, ROSLYN, NY, 11576, US

(21) Appl. No.: 12/576,802

(22) Filed: Oct. 9, 2009

Related U.S. Application Data
(60) Provisional application No. 61/104,253, filed on Oct. 9, 2008.

(51) Int. Cl. G06Q 40/00; G06Q 10/00

(52) U.S. Cl. 705/10; 705/7

(57) ABSTRACT

One embodiment relates to a system for valuing an entity. In at least one embodiment, the system can be utilized over a computer network. The system can include a processor, computer or means for determining a financial value via at least one calculation, a processor, computer or means for determining a trust value via at least one calculation, a processor, computer or means for determining a total value by combining a determination of a financial value and a trust value, and a processor, computer or means for presenting the total value to an entity. In addition, in at least one embodiment, there is also a process for valuing an entity comprising determining a financial value via at least one calculation and then determining a trust value via at least one calculation, and then determining a total value by combining a determination of a financial value and a trust value and then presenting the total value to an entity. This process can be performed using a processor, computer or computer network.

### CROSS REFERENCE TO RELATED APPLICATIONS

This application is a non provisional application which hereby claims priority from U.S. Provisional application Ser. No. 61/104,253 to Amy Lauren Young titled “System and Method for Defining Value for a Company” filed on Oct. 9, 2008, the disclosure of which is hereby incorporated herein by reference in its entirety.

### BACKGROUND

One embodiment relates to a system and a process for determining the value of an entity. With a recent breakdown in valuation of companies on Wall Street and with the recent collapse of valuations of public and private companies listed on the New York Stock Exchange as well as Nasdaq and other listing companies, there is now a need for a computerized solution to correctly or more accurately value a company based upon more than just quantitative terms.

### SUMMARY

The invention relates to a unique methodology to value assets, investments, and companies using financial algorithms in addition to human interpretation. One embodiment relates to a system for valuing an entity. In at least one embodiment, the system can be utilized over a computer network. The system can include a processor, computer or means for determining a financial value via at least one calculation, a processor, computer or means for determining a trust value via at least one calculation, a processor, computer or means for determining a total value by combining a determination of a financial value and a trust value, and a processor, computer or means for presenting the total value to an entity.

The term entity, can include company, corporation, LLC, charitable organization, individual entity, partnership, business, or their equivalent either in the United States, or in other countries.

In addition, in at least one embodiment, there is also a process for valuing an entity comprising the step of determining a financial value via at least one calculation and then determining a trust value via at least one calculation, and then determining a total value by combining a determination of a financial value and a trust value and then presenting the total value to an entity. This process can be performed using a processor, computer or computer network.

In at least one optional embodiment, which can include either one of the embodiments disclosed above, there is a trust platform, which involves presenting at least one question to at least one employee of the entity to determine the employee's perception of the entity. There is also an optional step, means or system for presenting at least one question to at least one owner of the entity to determine a goal of the at least one owner. There is also an optional step, means or system for presenting at least one question to at least one customer of the entity to determine the at least one customer's perception of the entity. In addition there is also an optional step for calculating a trust value based upon at least one answer provided by the employee, the owner and the customer, including but not limited to suppliers, philanthropists, or charities, boards of directors, and financial partners.

This system and process can also be used to determine the value of a not for profit or charitable organization wherein the trust platform can be used in conjunction with common methods for determining the financial health of a charitable organization.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1A is a schematic block diagram of a computer system including a general purpose computer which when programmed, becomes a special purpose computer;

FIG. 1B is a schematic block diagram of the server which is an example of a device for performing the processes shown in FIGS. 2-17;

FIG. 2 is a block diagram of the pricing model program which includes a finance platform and a trust platform;

FIG. 3 is a flow chart of a process for evaluating a company;

FIG. 4 is a flow chart of the process for enrolling in the program;

FIG. 5A is a flow chart for the process for determining the value of the finance platform;

FIG. 5B is a flow chart for the process for determining the value in the trust platform;

FIG. 6 is a more detailed flow chart for the process for determining the value of the finance platform;

FIG. 7 is a block diagram showing the categories for determining country specific factors;

FIG. 8 is a flow chart for the process for determining company specific factors;

FIG. 9 is a block diagram showing all of the categories for company specific factors;

FIG. 10 is a block diagram showing all of the sub categories for financial management and oversight which are found in the company specific factors of FIG. 9;

FIG. 11 is a block diagram showing all of the sub categories for vision found in the company specific factors of FIG. 9;

FIG. 12 is a block diagram showing the sub categories for the category of relationships with others found in the company specific factors of FIG. 9;

FIG. 13 is a block diagram showing the sub categories for the category of products and services found in the company specific factors of FIG. 9;

FIG. 14 is a block diagram showing the sub categories for the category of social and environmental responsibility found in the company specific factors of FIG. 9;

FIG. 15 is a block diagram showing the sub categories for the category of marketing and technology strategy found in the company specific factors of FIG. 9;

FIG. 16 is a block diagram showing the sub categories for the category of strategic planning found in the company specific factors of FIG. 9; and

FIG. 17 is a block diagram showing the sub categories for the category of determining legal responsibilities.

### DETAILED DESCRIPTION

There is disclosed a system and process for valuing a company or business entity which uses unique valuation methodology and systems. The unique valuation methodology and systems are formed from a combination of algorithms which include a particular process for determining a value of a company.

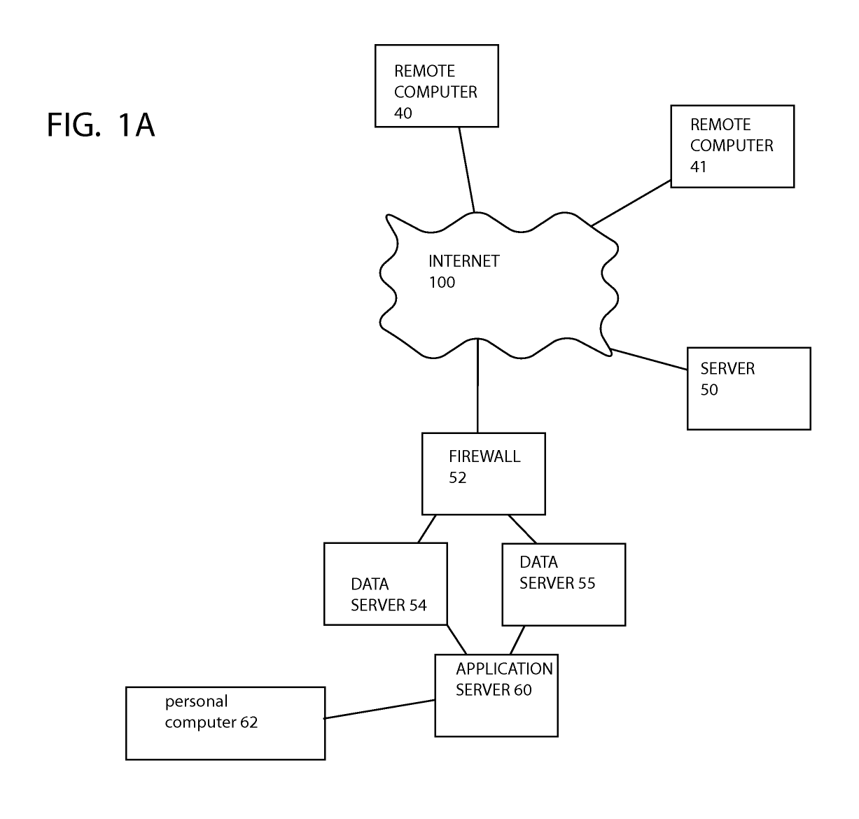

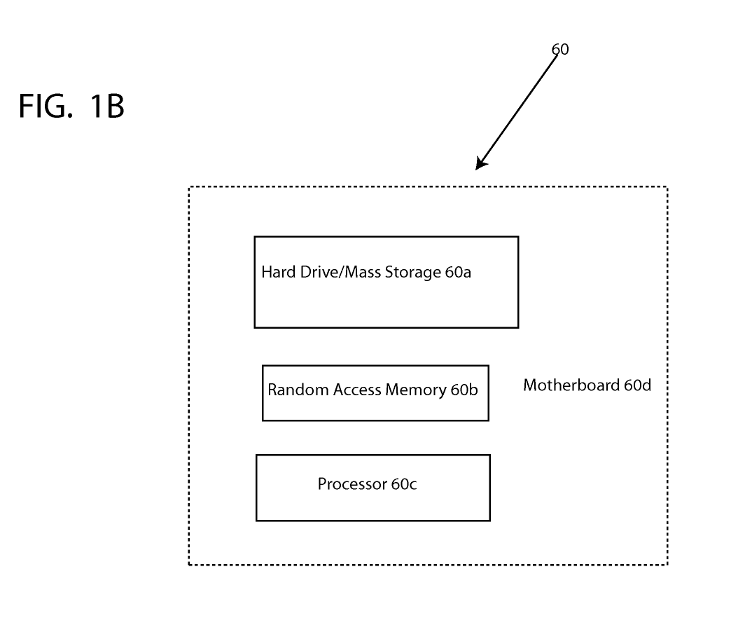

For example, as shown in FIG. 1A, there is disclosed a computer system which can be used to evaluate a company. In this case, this computer system includes an application server 60 which is in communication with a terminal such as a personal computer 62. There are also optional data servers in communication with the application server.

Data servers 54 and 55 are in communication with application server 60 as well as with firewall 52. In this case, connected on the other side of firewall 52 is the internet 100. A general server 50 is shown as in communication with the internet 100 as well. Remote computers 40 and 41 are also in communication with the internet as well. The example shown in FIG. 1 is simply an example of a layout of computers on a computer network which can be used along with the process for determining the valuation of a company as discussed below.

This basic process is performed using one or more algorithms or solutions which are provided on an application server 60 which is shown in greater detail in FIG. 1B. Application server 60 includes a hard drive or mass storage 60a, random access memory 60b, a processor 60c, and a motherboard which connects these components together and allows these components to communicate with each other. In addition application server 60 also includes a communication transceiver 60d which can either be in the form of an Ethernet NIC card or wireless communication device for communicating with other devices.

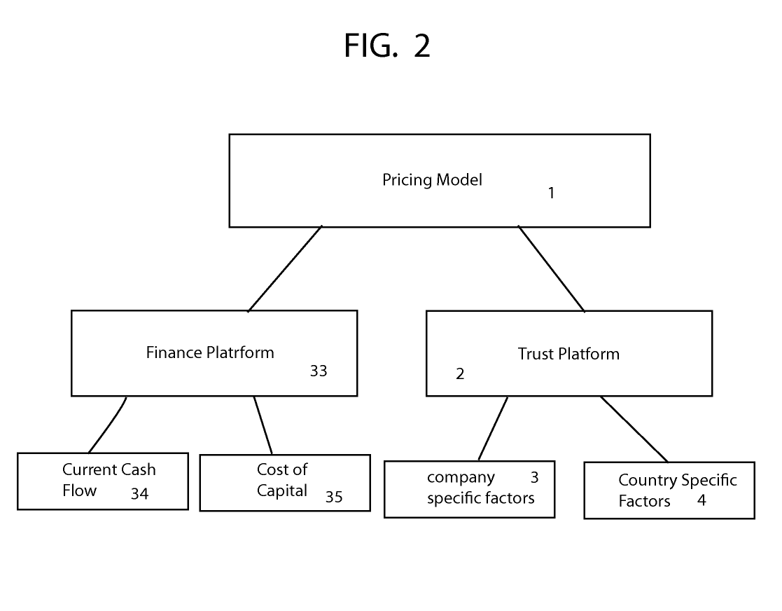

FIG. 2 shows as basic block diagram for evaluating a company. At the top is a pricing model 1, which relies on a finance platform 33 and a trust platform 2. For example, the Finance platform 33 relies on generally accepted accounting principles or GAAP, and utilizes models relying on current cash flow 34 and the cost of capital 35 to determine from a financial perspective the value of the company. The blocks designating the cash flow and the cost of capital represent the basic categories for allocating information used to create a valuation of a company or entity.

The Trust platform 2 relies on company specific factors 3, and country specific factors 4. The determination of a company's or entity's value is computed generally first by determining the financial value of the company, and then applying a multiplier based upon a percentage to the estimated financial value of the company.

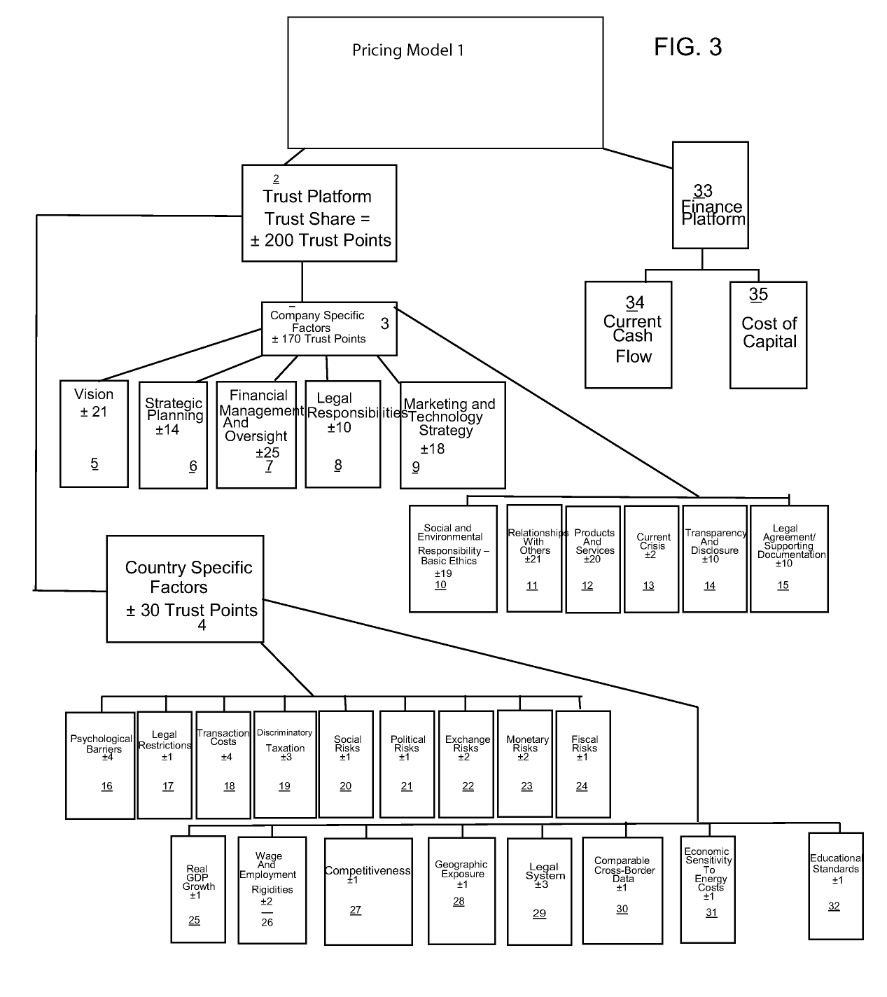

FIG. 3 discloses an overview block diagram showing the different facets of both the trust platform as well as the finance platform. In this case, the trust platform 2 is used to further define the value of the finance platform. The finance platform 33 as disclosed above is a platform used to determine the value of the current cash flow 34 or the cost of capital 35 as well.

In addition, the trust platform 2 shows blocks of information for both company specific factors 3 and country specific factors 4. Under the company specific factors there are blocks of information relating to vision 5, strategic planning 6, financial management 7, legal responsibilities, 8, marketing and technology strategy 9, social and environmental responsibility 10, relationships with others 11, products and services 12, how a company is handling any current crisis 13, transparency and disclosure 14, and legal agreement supporting documentation 15. In addition, there are also country specific factors 4, which also include blocks of information including psychological barriers 16, legal restrictions 17, transaction costs 18, discriminatory taxation 19, social risks 20, political risks 21, exchange risks 22, monetary risks 23, fiscal risks 24, real GDP growth 25, wage and employment rigidities 26, competitiveness 27, geographic exposure 28, legal system 29, comparable cross-border data 30, economic sensitivity to energy costs 31, and educational standards 32.

For each of the country specific factors, each of the countries are ranked. For each of the sets of possible points that can be awarded, the countries are ranked in each of the above factors. For example, regarding transaction costs which results in a point swing of +/−four (4) points each of the approximately 200 countries in the world is ranked in terms of known transaction costs including bank fees, regulatory taxes, monetary exchange costs etc. Therefore, the approximately 200 countries in the world would be ranked and then separated into nine different ranking sets including approximately 22 countries in each one of the nine following ranking sets: (−4), (−3), (−2), (−1), (0), (1), (2), (3), (4). With each country ranked in this category of transaction costs, as well as in each trust category then the country specific factors can be quickly and easily calculated in an automatic manner such as through the use of a processor such as with processor 60c. For each category, a number is assigned so that a total score is determined for the trust platform. The total number of points that can be awarded can be continuously updated, while the rankings for each country in each category can also be continuously updated based upon new information that is provided. Information about each country can be obtained from both the CIA World Factbook, as well as taken from each country's state department information, information from their chamber of commerce, departments of trade etc. As this information is obtained, a database of this information is created which can then be continuously updated and perfected as it is used. For each of the point values listed below, the points awarded can include either end of the range, and any number in between including zero as provided above in the example relating to transaction costs.

As stated above while the points scores can be continuously changed the following are the scores for the country specific factors: psychological barriers 16: (+/−4); legal restrictions 17 (+/−1); transaction costs 18: (+/−4); discriminatory taxation: (+/−3); social risks 20 (+/−1); Political risks 21: (+/−1); Exchange risks 22: (+/−2); monetary risks 23: (+/−2); fiscal risks 24: (+/−1); Real GDP Growth 25: (+/−1); wage and employment growth 26: (+/−2); competitiveness: 27: (+/−1); geographic exposure 28: (+/−1); legal system 29: (+/−3); Comparable Cross Border Data 30: (+/−1); Economic sensitivity to energy costs 31: (+/−1); Educational standards 32: (+/−1).

In addition there are company specific factors as well. These company specific factors result in a total of +/−170 points which is determined as disclosed below.

To determine the company specific factors, information is collected and stored in particular categories or information boxes. The information boxes and their score range is as follows: vision 5: (+/−21); strategic planning 6 (+/−14); Financial management and oversight 7 (+/−25); legal responsibilities 8: (+/−10); marketing and technology strategy 9: (+/−18); social and environmental responsibility/responsibility basic ethics 10: (+/−19); relationship with others 11: (+/−21); products and services 12: (+/−20); current crisis 13: (+/−2); transparency and disclosure 14: (+/−10); and legal agreement/supporting documentation 15 (+/−10).

As can be seen from above, the company specific factors are weighted to be approximately 6× more weight than country specific factors. However, after numerous iterations and applications of the above application process, the weights can change.

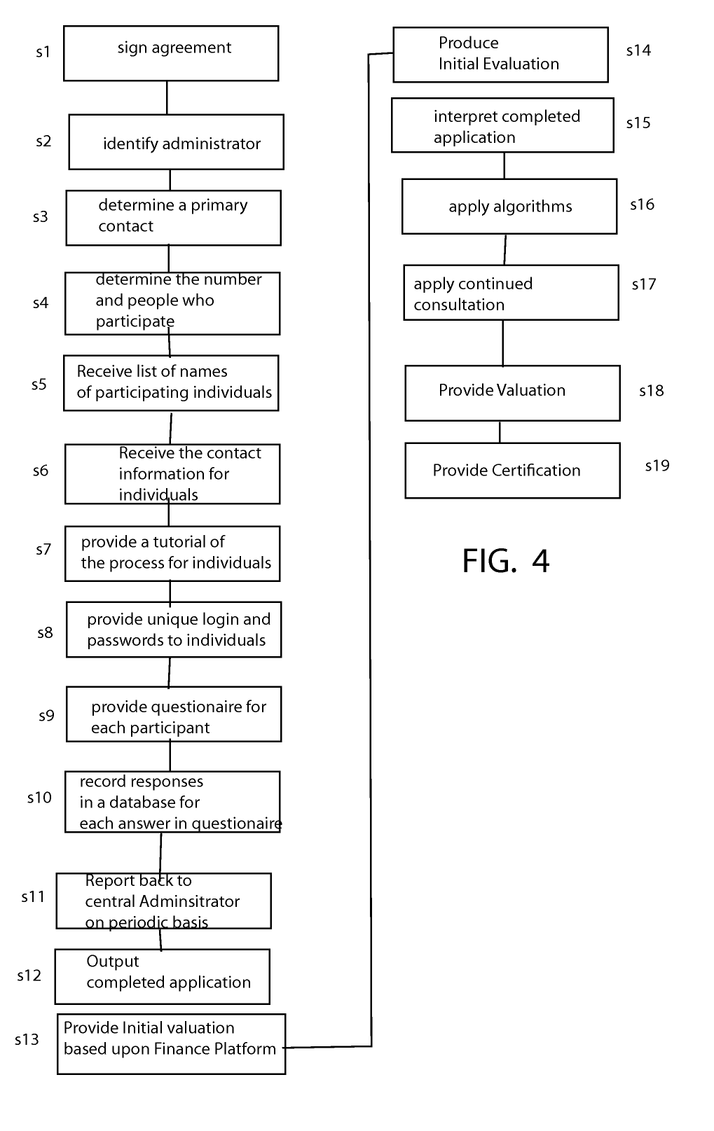

FIG. 4 shows a basic flow chart for the process for valuation of a company or entity. For example, step S1 involves signing an agreement between a valuation administrator and a company representative. The agreement is in the form of a contractual agreement between the two parties which allows the parties to proceed forward in an orderly manner regarding potential valuation of the company, consulting services provided by the valuation administrator and payment schedule. Next, in step S2, the valuation administrator identifies a company administrator for consultation. This company administrator is a person who would be used to consult with regarding the valuation of the company and who would be the person who has the ultimate authority on the process, as well as on the release of information for purposes of conducting the valuation. In step S3 the primary contact is determined, wherein the valuation administrator coordinates with the company to determine the person, who could also be the administrator, who will be the primary point of contact for all communication and transmission of information. Between the primary contact, the company administrator, and the valuation administrator, these parties would determine the number and types of people who would participate in the program. The types of people who would be reference could be taken from the group comprising or consisting of: Chief Executive Officer (CEO), Chairman, Chief Financial Officer, or CFO, Human Resources Director, Investor Relations, Customers of the company, Financial Lenders to the entity, Employees, Philanthropic Organizations, Board of Directors, Division Leaders, all primary leadership positions, Employees, Board of Directors, owners or shareholders of the entity, partners or suppliers, competitors, trade groups, members of the general public. Information can also be pulled from pre-existing studies, nominations from trade groups, awards, studies provided by analysts, consultants etc.

For charitable organizations, the same parties or people could apply as well as philanthropists, those who receive a benefit from the charity, and charitable monitoring agencies.

In many cases, the valuation administer may set a target for review of a minimum number of participants in a particular category. For example, while there is likely only one CEO or Chairman, the valuation administrator could set the target for a survey for a minimum number of customers such as 100 customers, or 1% of customers or even 5% of customers, or for example, 10% of the top 1% of customers. Other targets for other parties could be set such as 100 employees or 1% or 5% of employees, three (3) philanthropic organizations, all or some of the members of the board of directors, all division leaders, all or some of the lenders, all or some of the financial investors.

For purposes of evaluation the large number or percentage of each group, the more likely the final evaluation will be accurate since this would lead to a more accurate statistical sampling of the people who would factor into a valuation.

For the financial evaluation, the gathering of information would comprise standard information relating to financial accounting such as profit and loss statements, financial reports, balance sheets. Different methods to calculate the financial value of an entity could be used such as: 1) capital asset pricing model (CAPM); Business Valuation using weighted Average Cost of Capital (WACC), Build up Method; other asset based approaches such as the net book value or the fair market value. There are also other approaches such as market approaches which include a determination of supply and demand forces which drive the prices of assets to a certain equilibrium.

While many steps can be provided in any useful order, one example for the process for determining the value of an entity is explained below. This process is carried out using any know system, but in at least one example occurs via instructions obtained either from mass storage 60a, or random access memory 60b and which is then fed into processor 60c in a known manner. Therefore, in at least one embodiment, processor 60c is configured to perform the functions disclosed below, and each of these functions are therefore performed using a computer program operated by processor 60c in a known manner. The information then calculated is then stored in information storage blocks which can then be stored on either random access memory 60b in a temporary manner or in hard drive/or mass storage 60a in a more permanent manner. This information can also be communicated to other storage devices in a known manner as well.

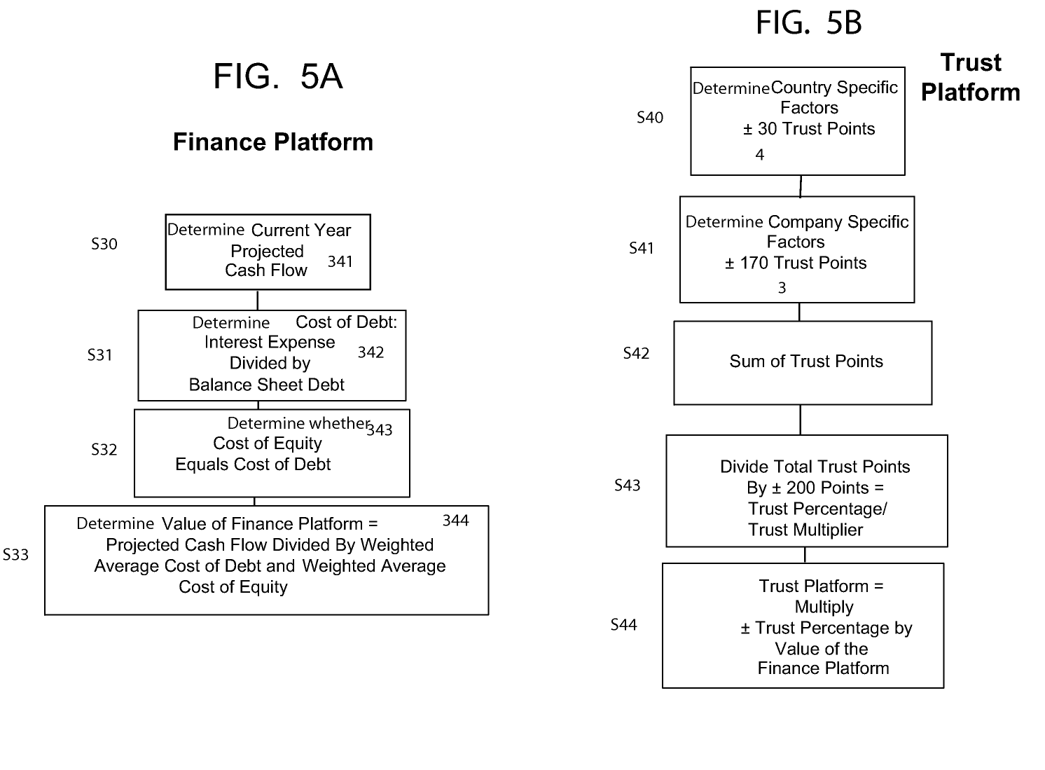

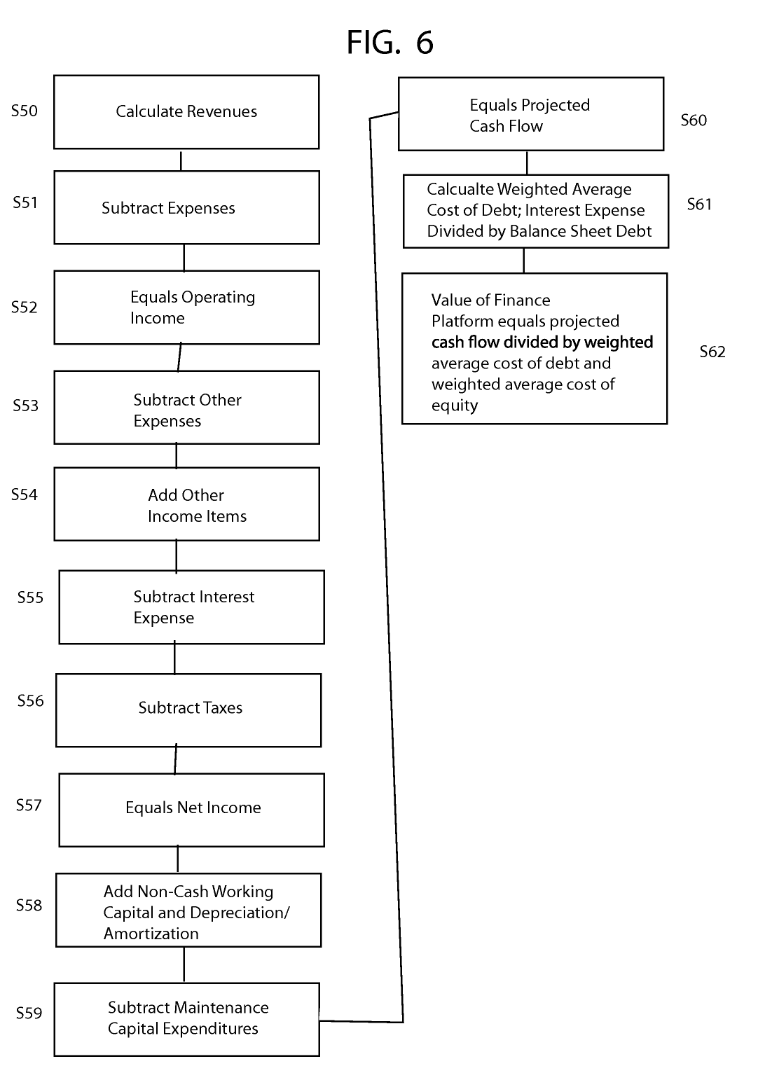

For example, FIG. 5A shows a flow chart for a sample process for determining a finance platform score which includes step S30 which results in determining a current year projected cash flow and then storing this information in information or storage block 341. Next, in step S31, the system determines the cost of debt by calculating the interest expense and then dividing it by the balance sheet debt and then storing this information in information storage block 342. Next, in step S32 the system determines the cost of equity and the cost of debt and determines whether the cost of equity equals the cost of debt, and then stores this information in information block 343. Next, in step S33 the system determines the value of the finance platform by determining the projected cash flow dividend by weighted average cost of debt and the weighted average cost of equity and then storing this information in information storage block 344.

FIG. 5B shows the process for determining the value of the trust platform which includes step S40 which includes determining country specific factors and then storing this information in its information or storage block. Next step S41 includes determining the company specific factors and then storing this information in its storage block. Next, in step S42 the total of the trust points is summed up. This amount in step S43 is then divided by the total number of points, which in this example is 200 points to obtain a percentage or trust multiplier. Next, the trust platform multiplier is applied to the value of the finance platform to obtain a valuation of a company or entity.

FIG. 6 shows an in depth flow chart for determining the value of the finance platform. As described above, the finance platform value is generally taken from Generally Accepted Accounting Principles. This process can start at any time when an analyst or the system obtains the requisite financial information. For example, this process starts with step S50, which includes calculating the revenues of the company. Step S51 then process to where the expenses are subtracted from the revenues. In step S52, this calculation then leads to operating income which is determined. Next, the other expenses are subtracted from this amount in step S53.

In the next step, step S54 the other income items are added, while in step S55, the interest expense is subtracted. Next, in step S56, taxes are subtracted, while in step S57, net income is determined. Next, in step S58, non cash working capital and Depreciation and amortization is added. In step S59, maintenance and capital expenditures are subtracted, to determine in step S60, the projected cash flow. Next in step S61, the weighted average of cost of debt, which includes the interest expense divided by the balance sheet debt in step S61. Next in step S62, the value of the finance platform is finally calculated to be the projected cash flow divided by weighted average cost of debt and weighted average cost of equity.

As stated above, to determine the total valuation this finance platform valuation is then modified by a trust value, taken from the trust value platform.

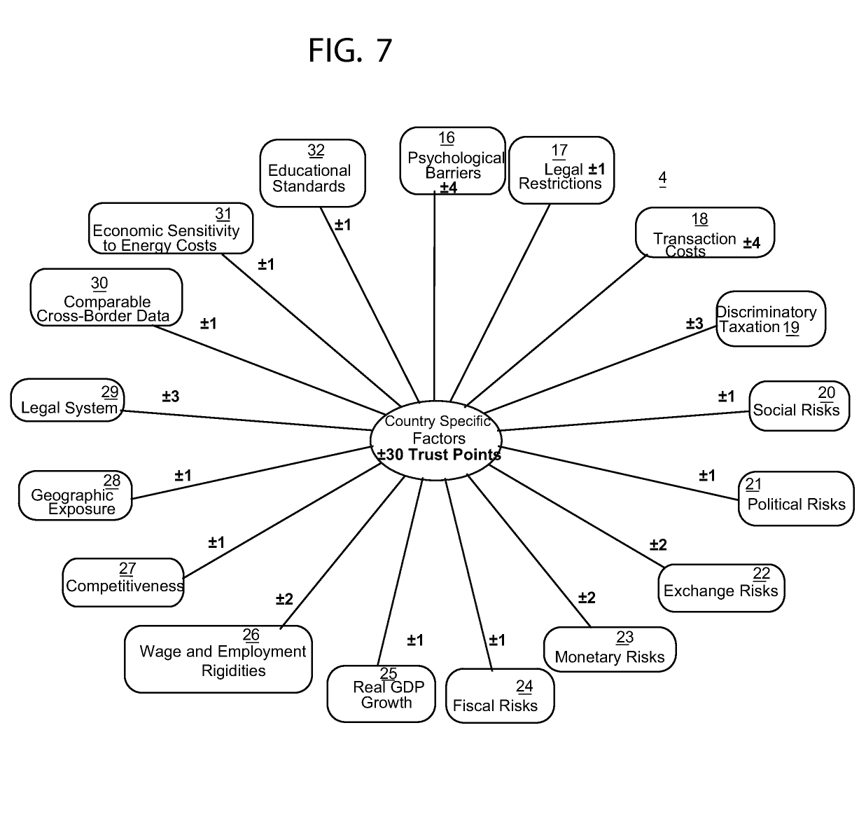

While FIG. 5B showed the overall flowchart for the trust platform, FIG. 7 shows the block diagram for the determination for country specific factors.

The country specific factors as described above include the following blocks of information: psychological barriers 16 (differences in culture); legal restrictions 17; transaction costs 18; discriminatory taxation 19 (taxes not categorized in the transaction costs); social risks 20 (risk of social upheaval); political risks 21 (risk of changes in government); exchange risks 22 (risks associated with volatility of exchange rate); monetary risks 23 (risks to the currency/monetary policy outside of the exchange risks); fiscal risks 24 (risks associated with government spending); real GDP growth 25; wage and employment rigidities 26; competitiveness 27 (business climate); geographic exposure 28 (benefits or burdens such as likelihood of natural disasters); legal system 29 (information or ranking outside of legal restriction category); comparable cross border data 30; economic sensitivity to energy costs 31; educational standards 32. As stated above, the weights of each of these categories can be changed based upon subsequent modeling or use which may result in changes to the weighted average of each of the above categories. In addition, in this case, no flowchart is provided showing a set order for calculation because each of these categories can be calculated in any order.

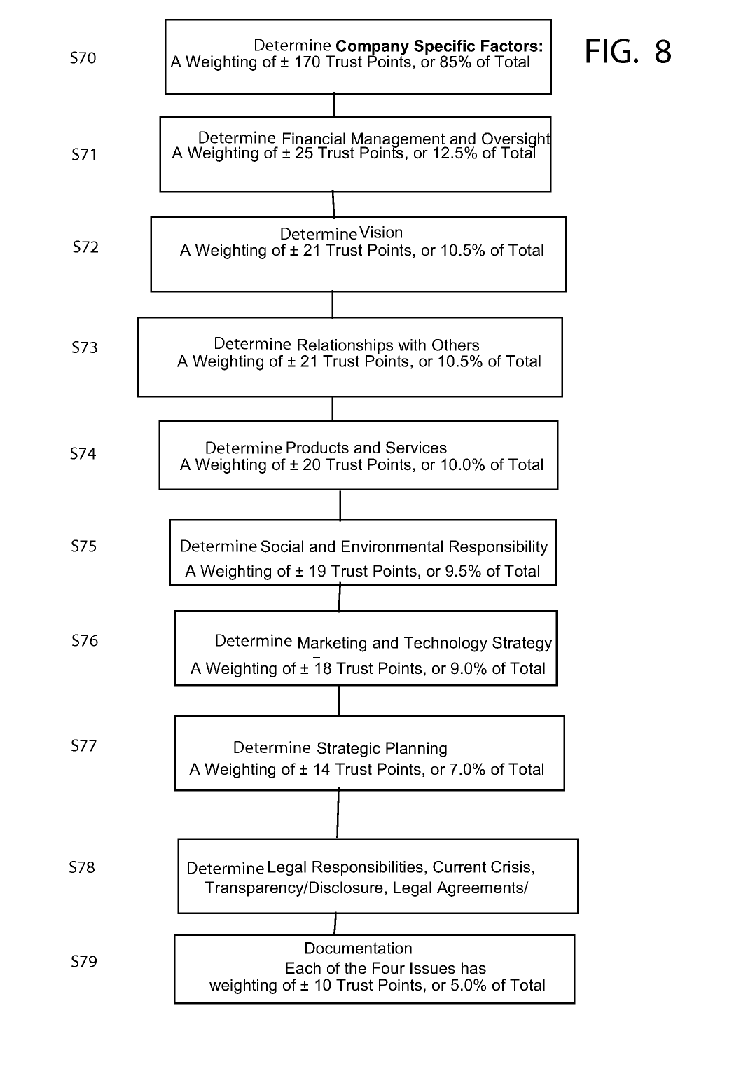

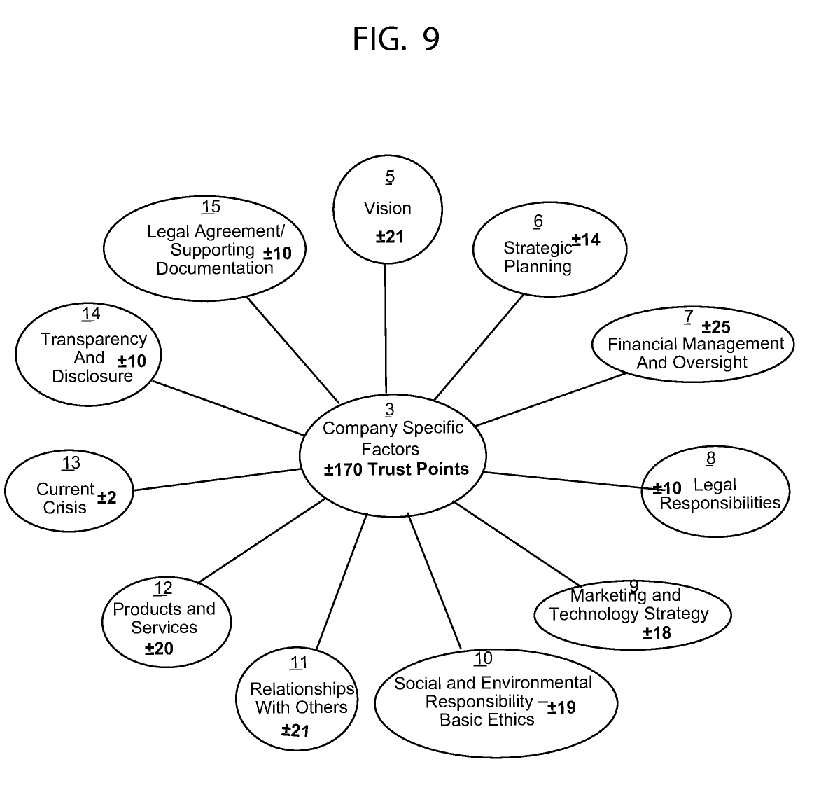

FIG. 8 shows an example of the flow chart for determining company specific factors. As stated above, each of these steps may be performed in any different feasible order, however FIG. 8 is shown simply as an example. FIG. 9 shows the general block diagram for this as well.

As disclosed above, based upon previous rankings of companies an existing company is then compared and then placed in one of the appropriate valuation categories based upon a database of past company valuations and/or based upon the past experience of the analyst in dealing with companies. This ranking can also be based upon or influenced by a questionnaire provided by the client to the system/analyst wherein the questionnaire asks the client/client's representative to rank each of the qualities of the company based upon the above cited subjects. A score is then created based either on the analysts grade, the client's view or grade or based upon a combination of both.

For example, step S71 includes determining financial management and oversight. This valuation is taken from the fitness or quality of the financial information which is provided to the system/analyst in the course of reviewing financial information for the financial platform.

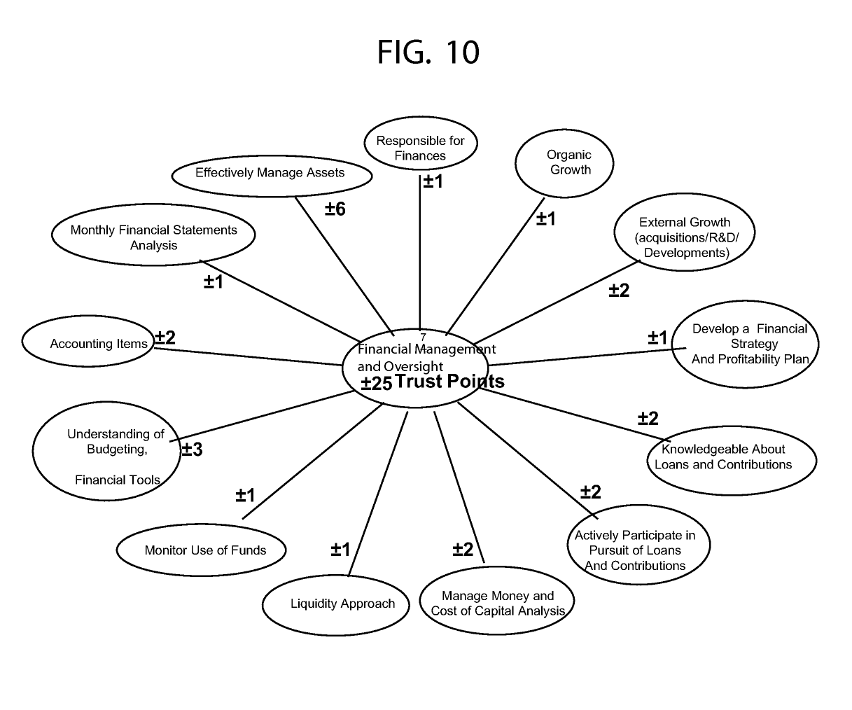

FIG. 10 shows the different categories/subcategories used in determining the score. For example for each entity there is an inquiry into at least one of the following categories with an associated value to determine whether the entity: is responsible for its finances (+/−1); has organic growth (+/−1); has external growth (+/−2); develops a financial strategy and profitability plan (+/−1); is knowledgeable about loans and contributions (+/−2); actively participates in pursuit of loans and contributions (+/−2); manages money and conducts a cost of capital analysis (+/−2); has a liquidity approach (+/−1); monitors the use of funds (+/−1); understands budgeting, uses common financial tools (+/−3); follows accounting items (+/−2); uses monthly financial statement analysis (+/−1); effectively manages assets (+/−6).

Next, step S72 involves determining vision for the company. This information can be obtained by the analyst questioning key personnel in the company to determine the focus or goals for the company. Examples of the information or questions provided could be to request a mission statement and then to determine whether the mission statement is appropriate for the business model and also determine how closely the company follows the mission statement.

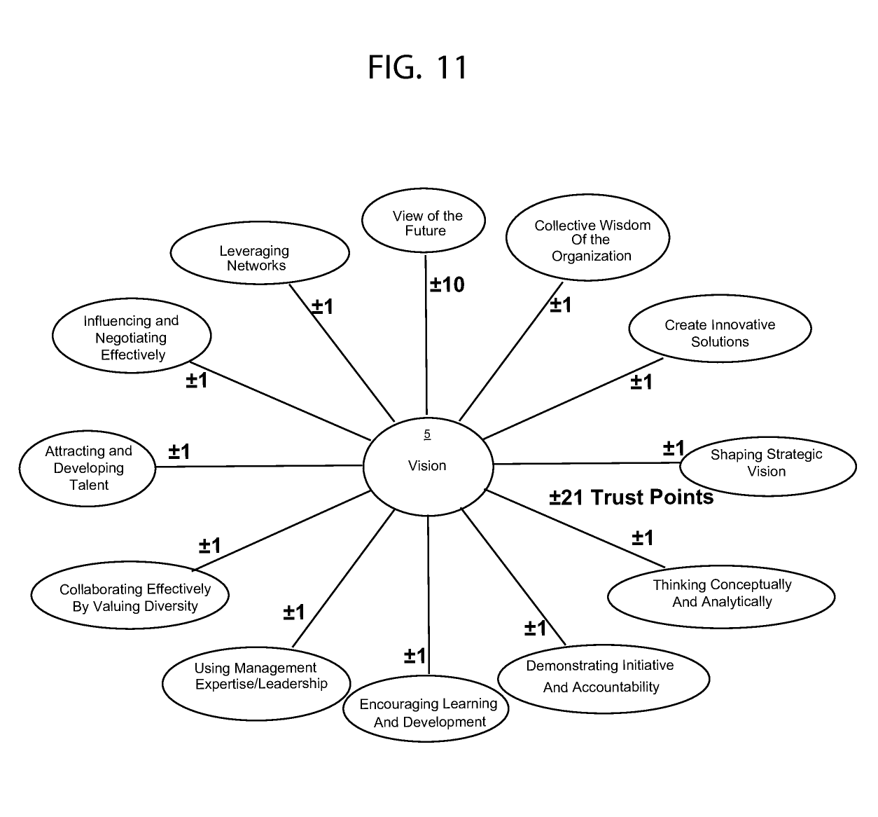

FIG. 11 shows the different categories/subcategories used in determining the score. For example for each entity there is an inquiry into at least one of the following categories with an associated value to determine whether or how the entity: views the future (+/−10); has collective wisdom of the organization (+/−1); creates innovative solutions (+/−1); shapes a strategic vision (+/−1); thinks conceptually and analytically (+/−1); demonstrates initiative and accountability (+/−1); encourages learning and development (+/−1); uses management expertise/leadership (+/−1); collaborates effectively by valuing diversity (+/−1); attracts and develops talent (+/−1); influences and negotiates effectively (+/−1); leverages networks (+/−1).

Next step S73 involves determining the relationship with others, meaning how well employees in the client organization interact with each other as well as how well the company as a whole interacts with other companies, including competitors, as well as associates or outside contractors. Determining factors can include the number or level of disputes, either within or outside of the organization, the morale of the employees, etc.

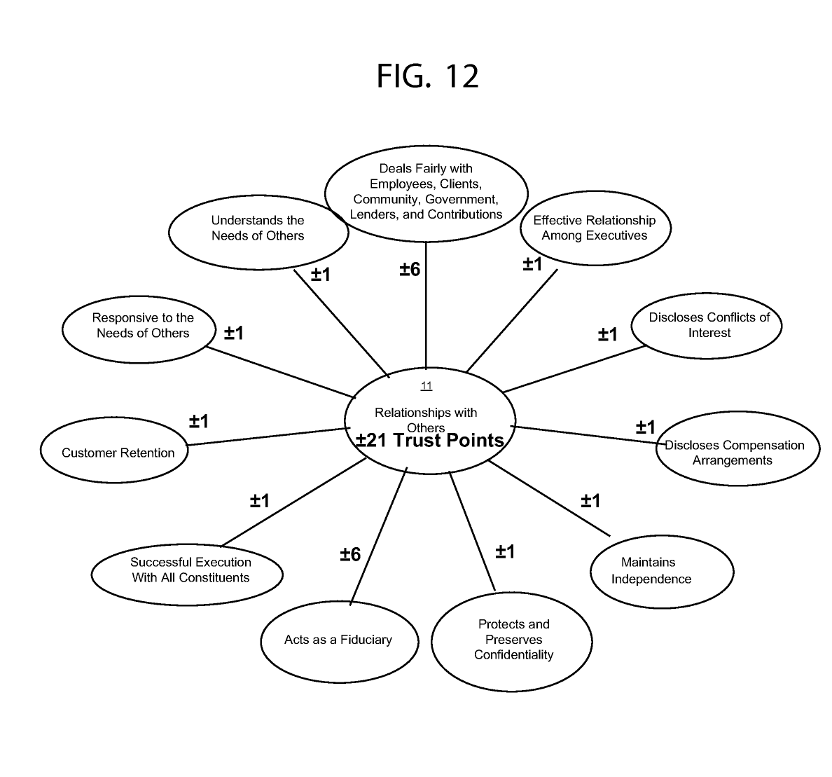

FIG. 12 shows the different categories/subcategories used in determining the score. For example for each entity there is an inquiry into at least one of the following categories with an associated value to determine whether or how the entity: deals fairly with employees, clients, community, government, lenders and contributors (+/−6); has effective relationships among executives (+/−1); discloses conflicts of interest (+/−1); discloses compensation arrangements (+/−1); maintains independence (+/−1); protects and preserves confidentiality (+/−1); acts as a fiduciary (+/−6); has successful execution with all constituents (+/−1); has customer retention (+/−1); is responsive to the needs of others (+/−1); and understands the needs of others (+/−1).

Step S74 involves determining the quality of the products and services. Information relating to this information block can include outside surveys by outside organizations which may rank the companies products and services in general or based upon competitors. Examples of outside organizations may include JD Power and Associates® rankings, “Consumer Reports”®, or particular trade organizations which provide rankings. Surveys can also be conducted of clients customers and/or employees of the evaluated company to determine this information as well.

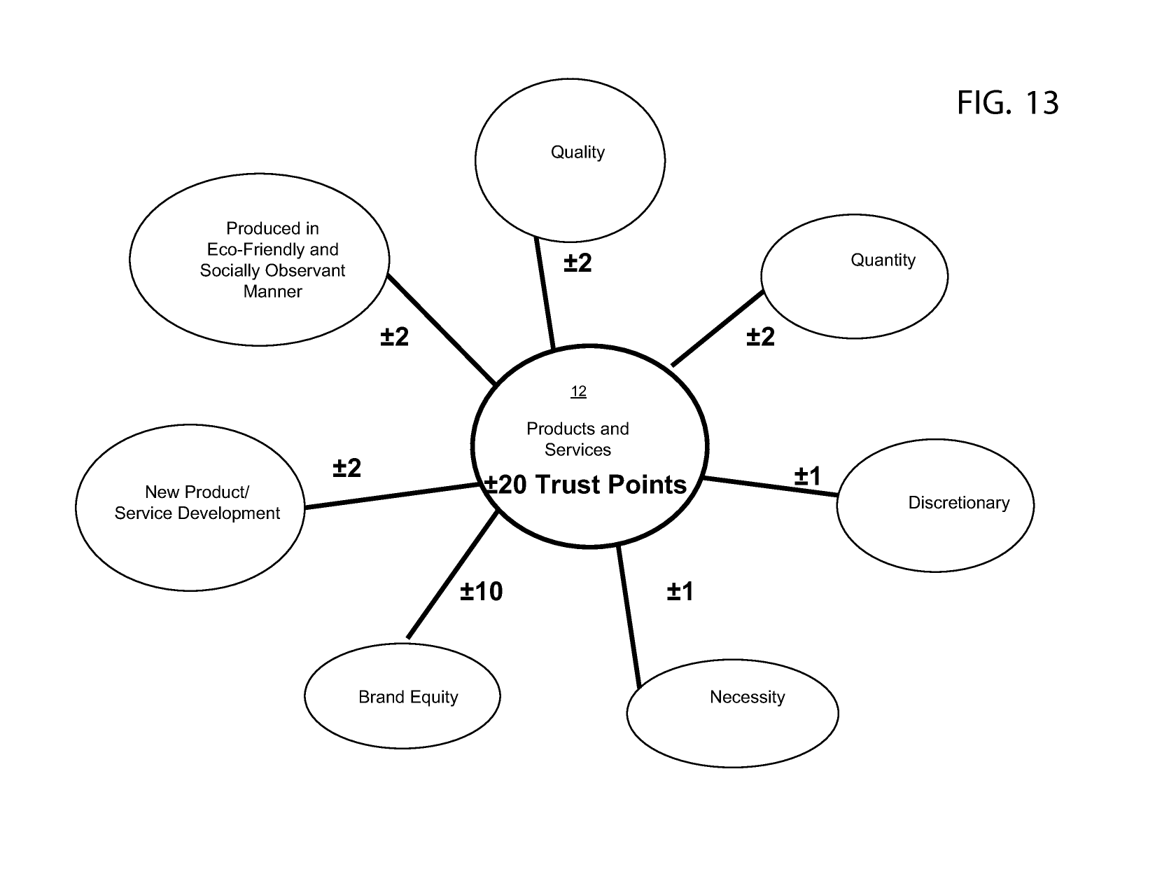

FIG. 13 shows the different categories/subcategories used in determining the score. For example for each entity there is an inquiry into at least one of the following categories with an associated value to determine whether or how the entity: has quality products (+/−2); has a quantity of products (+/−2); has products that are discretionary (+/−1); has products that are a necessity (+/−1); has products that have brand equity (+/−10); has products that are new product or service development (+/−2); has products that are produced in an eco-friendly and socially observant manner (+/−2).

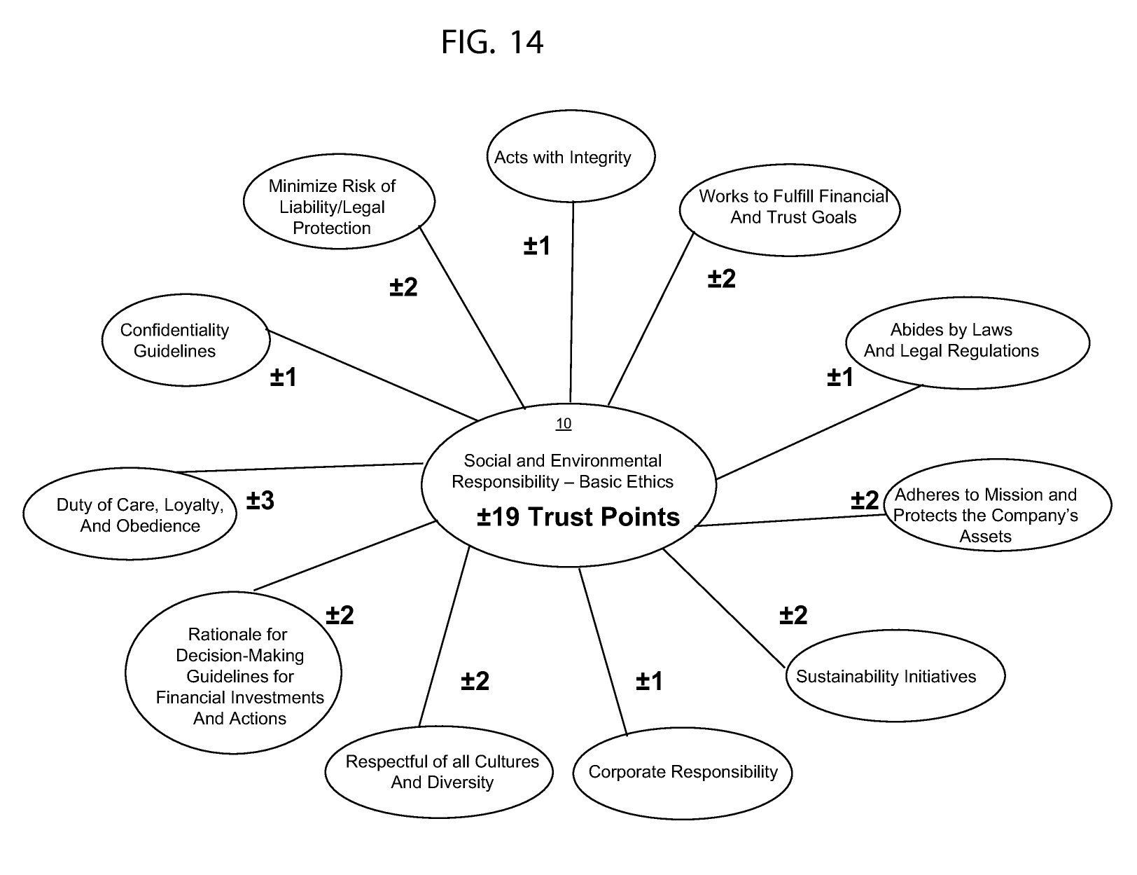

Step S75 includes determining the level of social and environmental responsibility. This information can be determined from a questionnaire provided to employees, clients, customers, as well as to non governmental organizations as well as determined whether there are any governmental violations of any social or environmental laws. Examples of the categories provided are shown in FIG. 14 and are: whether the entity: acts with integrity (+/−1); works to fulfill financial and trust goals (+/−2); abides by laws and legal regulations (+/−1); adheres to mission and protects the company's assets (+/−2); uses sustainability initiatives (+/−2); follows corporate responsibility (+/−1); is respectful of all cultures and diversity/diversity initiatives or programs (+/−2); follows rational decision making guidelines for financial investments and actions (+/−2); uses duty of care loyalty, and obedience (+/−3); uses confidentiality guidelines (+/−1); minimizes risk of liability/legal protection (+/−2).

Step S76 involves determining marketing and technology strategy. This is determined using a questionnaire of the marketing department of the entity as well as determining whether the entity has won any awards in this department. In addition, a questionnaire of the customers can be used to determine how well the customers grasp the marketing or advertising strategy. With regard to the technology portion, questionnaires can be provided to the technology department as well as to vendors providing technology solutions. Outside ranking organization may also provide awards or insight into the effectiveness of the technology solution. The subcategories and values used can include determining:

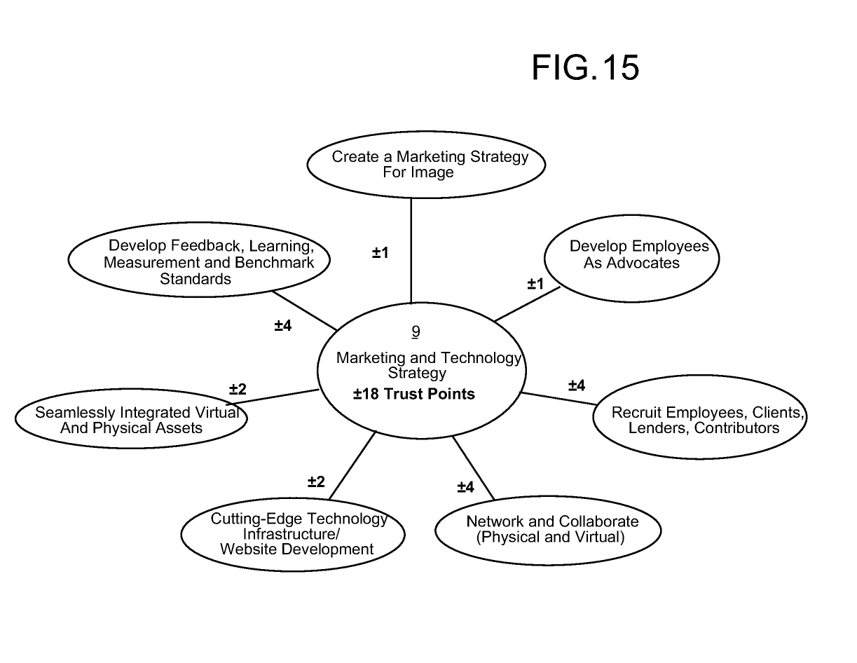

whether the entity: creates a marketing strategy for image (+/−1); develops employees as advocates (+/−1); recruits employees, clients, lenders, or contributors (+/−4); networks and collaborates (Physical and virtual) (+/−4); utilizes cutting edge technology infrastructure; website development (+/−2); seamlessly integrates virtual and physical assets (+/−2); develops feedback learning, measurement and benchmark standards (+/−4). These subcategories are shown in FIG. 15.

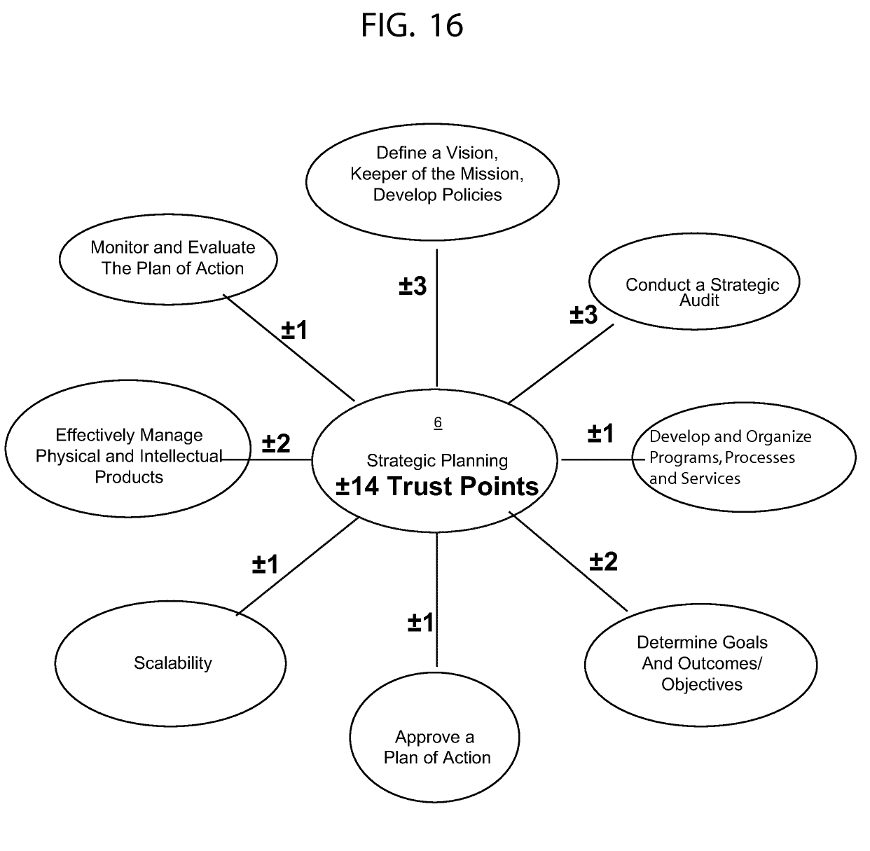

Next, step S77 involves determining the strategic planning of the entity. As above, the information can obtained via a questionnaire of employees, management, customers, vendors, outside ranking or industry award organizations or via the analyst's own experience or a combination of the above factors. FIG. 16 shows the subcategories which includes the following subcategories and values which involves determining whether or how well the entity:

Defines a vision, keeps a mission, and develops policies toward this goal, (+/−3); conducts a strategic audit (+/−3); develops and organizes programs, processes and services (+/−1); determines goals and outcomes/objectives (+/−2); approves of a plan of action (+/−1); has scalability (+/−1); Effectively Manages physical and intellectual products (+/−2); monitors and evaluates the plan of action (+/−1).

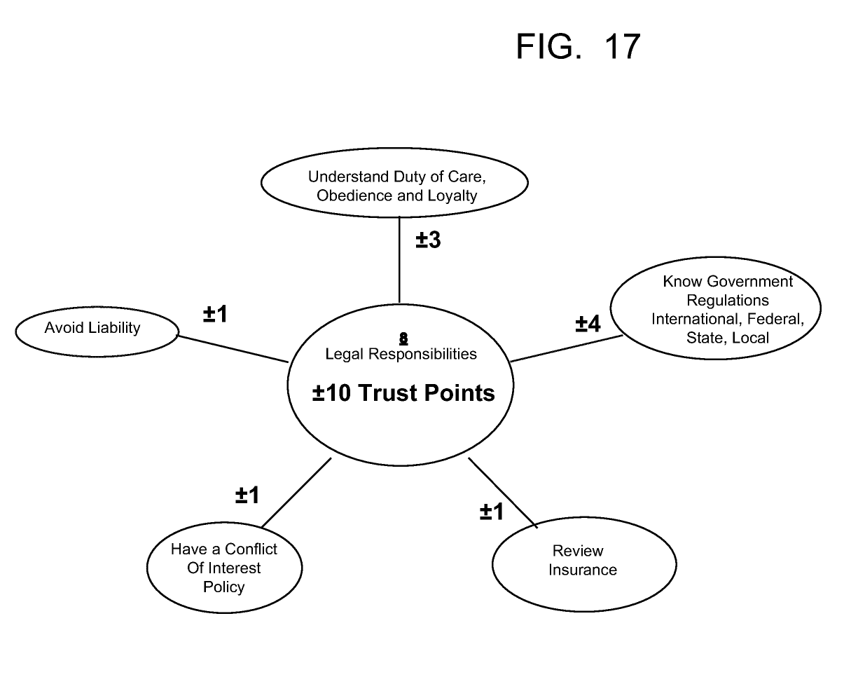

Next, step S78 involves determining the legal responsibilities, current crisis, transparency, disclosure and legal agreements. Information that can be obtained includes documents relating to legal agreements, surveys or rankings involving owners, employer's management of entity, employees, customers, competitors, or trade groups. FIG. 17 shows the subcategories for this determination.

Valuation in this category can include using subcategories including the following categories and valuation for whether an entity: understands the duty of care, obedience and loyalty (+/−3); knows government regulations, including international, federal, state and local (+/−4); reviews insurance (+/−1); has a conflict of interest policy (+/−1); and avoids liability (+/−1).

Once the valuation in each of these categories and subcategories is obtained, the values are stored and then a total value is calculated based upon each of these individual scores. As shown in FIG. 5B the total of the sum of the trust points for country specific factors and company specific factors is summed up in step S42, wherein in step S43, the total amount of the trust points is divided by the total number of points which in this example is 200 points to determine a percentage in step S43. Next in step S44, the total value is determined by multiplying the finance value with the trust percentage to determine the modified value. This total value is determined as shown in step S18 as well in FIG. 4. Next depending on the value provided, either of the total value or of the trust value, a certificate is provided to the entity as well indicating that the entity has been evaluated.

This model can also be applied to non profit or not for profit organizations which may or may not be tax exempt organizations which are either run as a business which charges fees or as a charity which accepts donations.

In this case, if the organization is run more as a charity, then the finance platform would generally not apply and a generally accepted financial model based upon valuing charities would be used.

Accordingly, while only a few embodiments of the present invention have been shown and described, it is obvious that many changes and modifications may be made thereunto without departing from the spirit and scope of the invention.

What is claimed is:

1. A system for valuing an entity comprising:
a) means for determining a financial value via at least one calculation performed by a computer;
b) means for determining a trust value via at least one calculation performed by a computer;
c) means for determining a total value by combining a determination of a financial value and a trust value;
d) means for presenting the total value to an entity.

2. The system as in claim 1, wherein said means for determining a financial value via at least one calculation comprises a computer.

3. The system as in claim 1, wherein said means for determining a financial value via at least one calculation comprises at least one of the following components: computer; computer network, calculating machine, and a server.

4. The system as in claim 1, wherein said means for determining a trust value via at least one calculation comprises a computer.

5. The system as in claim 1, wherein said means for determining a total value to an entity comprises a computer.

6. The system as in claim 1, wherein said means for determining a trust value comprises at least one of the following components: computer; computer network, calculating machine, and a server.

7. The system as in claim 1, wherein said means for determining a total value comprises computer; computer network, calculating machine, and a server.

8. The system as in claim 1, wherein said means for determining a trust value comprises a means for presenting at least one question to a user, and a means for calculating a trust value based upon an answer to said question.

9. The system as in claim 1, wherein said means for determining a financial value comprises a means for presenting at least one question to a user, and a means for calculating a trust value based upon an answer to said question.

10. The system as in claim 1, wherein said means for presenting the total value to an entity comprises a computer.

11. The system as in claim 1, wherein said means for determining a financial value, said means for determining a trust value and said means for presenting the total value to an entity are all positioned on a computer network.

12. A process for valuing an entity comprising:
a) determining a financial value via at least one calculation performed by a computer;
b) determining a trust value via at least one calculation;
c) determining a total value by combining a determination of a financial value and a trust value; and
d) presenting the total value to an entity.

13. The process as in claim 12, wherein said step of determining a trust value comprises presenting a plurality of questions to an entity's employees.

14. The process as in claim 12, wherein said step of determining a trust value comprises presenting a plurality of questions to an entity's owner.

15. The process as in claim 14, wherein said step of determining a trust value comprises presenting a plurality of questions to an entity's shareholders.

16. The process as in claim 14, wherein said step of determining a trust value comprises presenting a plurality of questions to an entity's customers.

17. The process as in claim 12, wherein said step of determining a total value comprises modifying a financial value by a determined trust value.

18. The process as in claim 12, further comprising presenting a list of business advice to an entity based upon a determined total value.

19. The process as in claim 12, further comprising the step of presenting a list of business advice for an entity based upon the determined trust value.

20. The process as in claim 12, wherein said step of determining a trust value comprises the following steps:
a) presenting at least one question to at least one employee of said entity to determine said at least one employee's perception of said entity;
b) presenting at least one question to at least one owner of said entity to determine a goal of said at least one owner;
c) presenting at least one question to at least one customer of said entity to determine said at least one customer's perception of said entity;
d) calculating via a computer a trust value based upon at least one answer provided by said at least one employee, said at least one owner and said at least one customer.
